(19) United States
(12) Patent Application Publication
(10) Pub. No.: US 2007/0236413 A1
(43) Pub. Date: Oct. 11, 2007

(54) FLUTED OPTICAL PLATE WITH INTERNAL LIGHT SOURCES AND SYSTEMS USING SAME

(75) Inventors: Mark D. Gehlsen, Eagan, MN (US); Susan E. Anderson, Woodbury, MN (US); James T. Richard, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/277,863

(22) Filed: Mar. 29, 2006

(51) Int. Cl. G09G 3/16

(52) U.S. Cl. 345/48

(57) ABSTRACT

A display system includes a programmable display panel having a viewing side and a back side, and a backlight unit disposed on the back side of the display panel. The backlight unit includes a fluted plate having a front layer facing the display panel, a back layer and connecting members connecting the front and back layers. Flutes are formed between the front and back layers and the connecting members. One or more light sources are disposed within at least one of the flutes of the fluted plate.

### FIELD OF THE INVENTION

The invention relates to optical displays, and more particularly to display systems that are directly illuminated by light sources from behind, such as may be used in LCD monitors and LCD televisions.

### BACKGROUND

Liquid crystal displays (LCDs) are optical displays used in devices such as laptop computers, hand-held calculators, digital watches and televisions. Some LCDs include a light source that is located to the side of the display, with a light guide positioned to guide the light from the light source to the back of the LCD panel. Other LCDs, for example some LCD monitors and LCD televisions (LCD-TVs), are directly illuminated using a number of light sources positioned behind the LCD panel. This arrangement is increasingly common with larger displays, because the light power requirements, to achieve a certain level of display brightness, increase with the square of the display size, whereas the space available for locating light sources along the side of the display only increases linearly with display size. In addition, some LCD applications, such as LCD-TVs, require that the display be bright enough to be viewed from a greater distance than other applications, and the viewing angle requirements for LCD-TVs are generally different from those for LCD monitors and hand-held devices.

Some LCD monitors and most LCD-TVs are commonly illuminated from behind by a number of cold cathode fluorescent lamps (CCFLs). These light sources are linear and stretch across the full width of the display, with the result that the back of the display is illuminated by a series of bright stripes separated by darker regions. Such an illumination profile is not desirable, and so optical layers are used to smooth the illumination profile at the back of the LCD device. These optical layers may also be used to increase the brightness of the image shown on the display system.

In small displays, for example on cell phones, the optical layers are typically simply stacked one on the other. With the increase in the size of display systems such as LCD-TVs and computer monitors, however, it is increasingly important that the optical layers are provided with support so as to reduce warping and distortion that may occur when operated under high temperature illumination conditions.

### SUMMARY OF THE INVENTION

One embodiment of the invention is directed to a display system that includes a programmable display panel having a viewing side and a back side, and a backlight unit disposed on the back side of the display panel. The backlight unit comprises a fluted plate having a front layer facing the display panel, a back layer and connecting members connecting the front and back layers, flutes being formed between the front and back layers and the connecting members. One or more light sources are disposed within at least one of the flutes of the fluted plate.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The invention may be more completely understood in consideration of the following detailed description in connection with the accompanying drawings, in which like reference numerals designate like elements, and wherein:

FIG. 1 schematically illustrates a display device that uses a light panel plate;

FIGS. 2A and 2B schematically illustrate different light panels;

FIGS. 3A and 3B schematically illustrate diffusing light panels;

FIGS. 4A-4C schematically illustrate light panels provided with a brightness enhancing surface;

FIGS. 5A-5D schematically illustrate light panels provided with a reflecting polarizer;

FIGS. 6A and 6B schematically illustrate the construction of a fluted plate using a spine attached to an optical film;

FIGS. 7A and 7B schematically illustrate the construction of a fluted plate using a double-sided spine attached to optical films;

FIG. 8A schematically illustrates a cross-section through a plate of a light panel;

FIGS. 8B and 8C schematically illustrate cross-sectional views of light panels that use different types of light sources;

FIG. 9 schematically illustrates a cross-sectional view of a light panel in which elongated light sources are positioned across a number of flutes of a plate;

FIG. 10 schematically illustrates a display system having a heat transfer medium flow through flutes of the fluted plate; and

FIG. 11A schematically illustrates in plan view and FIG. 11B schematically illustrates in side view a fluted plate containing light sources within the flutes.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to programmable displays such as liquid crystal displays (LCDs, or LC displays), and is applicable to LCDs that are illuminated from behind.

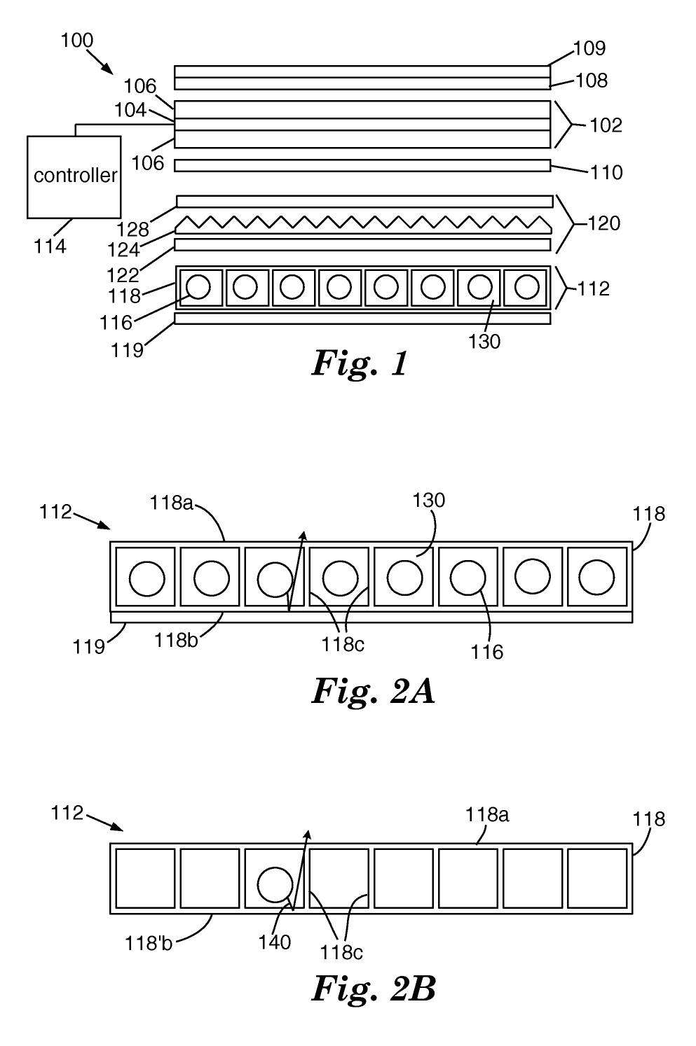

A schematic exploded view of a direct-lit LC display device 100 is presented in FIG. 1. Such a display device 100 may be used, for example, in an LCD monitor or LCD-TV. The display device 100 is based on the use of an LC panel 102, which typically comprises a layer of LC 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers are located outside the LC panel 102. The absorbing polarizers 108, 110 and the LC panel 102 in combination control the transmission of light from the backlight 112 through the display 100 to the viewer. In some LC displays, the absorbing polarizers 108, 110 may be arranged with their transmission axes perpendicular. When a pixel of the LC layer 104 is not activated, it may not change the polarization of light passing therethrough. Accordingly, light that passes through the lower absorbing polarizer 110 is absorbed by the upper absorbing polarizer 108, when the absorbing polarizers 108, 110 are aligned perpendicularly. When the pixel is activated, on the other, hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 114, results in the light passing out of the display at certain desired locations, thus forming an image seen by the viewer. The controller may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

It will be appreciated that some types of LC displays may operate in a manner different from that described above. For example, the absorbing polarizers may be aligned parallel and the LC panel may rotate the polarization of the light when in an unactivated state. In addition, the display device may be configured in many different ways. The light panel described below is believed to suitable for use with many different configurations of display device and is not limited to those configurations described herein.

The backlight 112, which illuminates the display panel from behind, includes a number of light sources 116 disposed within channels, or flutes 130, of a plate 118. One exemplary embodiment of the fluted plate 118 is schematically illustrated in greater detail in FIG. 2A. The fluted plate 118 includes a front layer 118a, a back layer 118b and a number of connecting members 118c that attach the front layer 118a to the back layer 118b. The spaces, or open volumes, formed between the front layer 118a, the back layer 118b and connecting members 118c are referred to as the flutes 130. Different embodiments of the fluted plate 118 that may be used in the present invention are described in greater detail in commonly owned U.S. patent application Ser. No. 11/276,442, “Optical Display with Fluted Optical Plate”, filed Feb. 28, 2006 and incorporated herein by reference.

Different types of light sources 116 may be used within the fluted plate 118. For example, linear, cold cathode, fluorescent tubes may be used as the light sources 116. Other types of light sources may also be used, such as filament or arc lamps, light emitting diodes (LEDs), lasers, flat fluorescent panels or external fluorescent lamps. This list of light sources is not intended to be limiting or exhaustive, but only exemplary.

A reflector 119 may be used for reflecting light propagating in a direction away from the LC panel 102. Such light may arise within the light sources 116 or may be reflected towards the reflector 119 from some other element in the display device 100, for example as is explained below. The reflector 119 may be a specular reflector or may be a diffuse reflector. One example of a specular reflector that may be used as the reflector 119 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in U.S. Pat. No. 6,780,355 (Kretman et al.), incorporated herein by reference. The reflector 119 may be separate from the fluted plate 118, as illustrated in FIG. 1, or may be attached to the plate 118, as schematically illustrated in FIG. 2A. The reflector 119 may be attached to the plate 118 using a suitable adhesive, for example an adhesive that it transparent to the light passing through the plate. Some examples of suitable adhesives include Optical Adhesives 9483, 8161, and 8162 available from 3M Company, St. Paul, Minn.

In other exemplary embodiments, a back layer 118′b of the fluted plate 118 may be reflective, as is schematically illustrated in FIG. 2B so that, for example, light 140 that propagates from the light source 116 in a direction towards the back layer 118′b is reflected towards the front layer 118a. The back layer 118′b may comprise a suitable type of reflective layer, for example a multilayer structure, or a diffusely reflective layer. In other exemplary embodiments, the back layer 118′b may include a reflecting layer, such as a metalized layer or a dielectric coating, that is attached to a substrate layer.

An arrangement 120 of light management layers may be positioned between the backlight 112 and the LC panel 102. The light management layers may be incorporated with the backlight 112, being attached directly or indirectly to the plate 118, or may separated from the backlight 112. The light management layers affect the light propagating from backlight 112 so as to improve the operation of the display device 100.

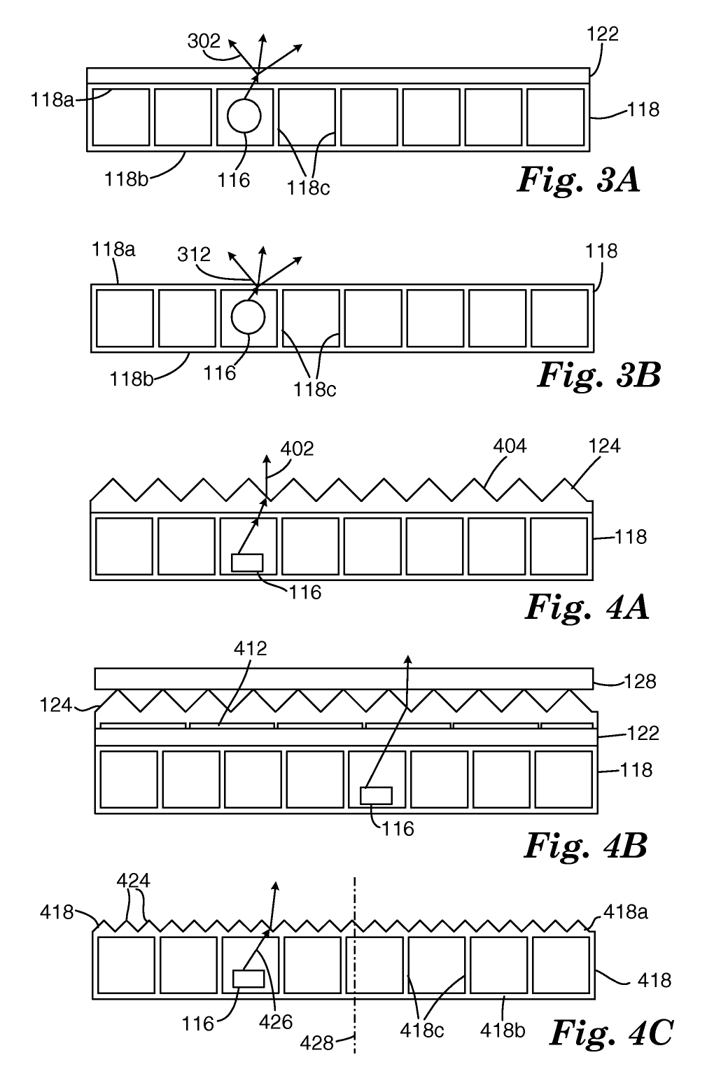

For example, the arrangement 120 of light management layers may include a diffuser layer 122. The diffuser layer 122 is typically used to diffuse the light received from the light sources, which results in an increase in the uniformity of the illumination light incident on the LC panel 102. Consequently, the image perceived by the viewer as being more uniformly bright than it would be without the diffuser layer 122. The diffuser layer 122 may include bulk diffusing particles distributed throughout the layer, or may include one or more surface diffusing structures, or a combination thereof. In some embodiments, the diffuser layer 122 may be separate from the plate 118. In other exemplary embodiments, the diffuser layer 122 may be attached to the plate 118, for example as schematically illustrated in FIG. 3A. In this exemplary embodiment, light 302 from the light source 116 is diffused by the diffuser layer attached to the plate 118. In some exemplary embodiments, the diffuser layer 122 may be attached to the plate 118 using an adhesive. In other exemplary embodiments, the diffuser layer may itself be a layer of adhesive that is loaded with diffusing particles.

In other exemplary embodiments, at least the front layer 118a of the plate 118 is formed of a diffusive material, for example as is schematically illustrated in FIG. 3B, so that the light 312 is diffused by the plate 118 itself.

The arrangement 120 of light management layers may also include one or more brightness enhancing layers 124. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic ridges that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT.

The brightness enhancing layer 124 may be positioned anywhere within the stack of light management layers 120, although it will be appreciated that, for certain configurations of light management layers, certain positions within the stack may provide more desirable system performance than other positions. In some embodiments, it may be desired that the brightness enhancing layer 124 is attached to the plate 118, for example as schematically illustrated in FIG. 4A. The brightness enhancing layer 124 may be attached to the plate 118 using a suitable adhesive. The figure shows how the light 402 is directed by the surface 404 of the brightness enhancing layer 124.

The brightness enhancement layer may be attached indirectly to the plate 118 via an intermediate layer, for example a diffuser layer. An exemplary embodiment of such a configuration is schematically illustrated in FIG. 4B. In this embodiment, a diffuser layer 122 is attached to fluted plate 118. A brightness enhancing layer 124 is attached to the diffuser layer 122. In some embodiments, there may be gaps 412 provided between the brightness enhancing layer 124 and the diffuser layer 122. In certain situations, these gaps 412 may help to increase the efficacy of the brightness enhancing layer 124. The attachment of a brightness enhancing layer to another layer is discussed in greater detail in U.S. Patent Publication 2003/0223216 A1 (Emmons et al.), incorporated herein by reference.

An additional layer, for example a reflecting polarizer layer 128, may optionally be attached to the structured surface of the brightness enhancing layer 124. The attachment of another optical layer to the structured surface of a brightness enhancing layer is discussed in greater detail in U.S. Pat. No. 6,846,089 (Stevenson et al.), incorporated herein by reference. The tips of the structured surface penetrate into a thin layer of adhesive applied to the optical layer. The adhesive is kept relatively thin, thinner than the feature size on the brightness enhancing layer so as to preserve a gap between at least part of the structured surface and the adhesive layer.

In other exemplary embodiments, the plate may be provided with an integrated brightness enhancing surface. For example, as illustrated in FIG. 4C, a fluted plate 418 is formed with a front layer 418a, a back layer 418b and connecting members 418c that connect the front and back layers 418a, 418b. The outer surface of the front layer 418a is a brightness enhancing surface 424 that redirects light 426 along a direction that is more closely parallel to the axis 428.

The arrangement 120 of light management layers may also include a reflective polarizer 128. In certain embodiments, the light sources 116 produce unpolarized light but the lower absorbing polarizer 110 only transmits a single polarization state, and so about half of the light generated by the light sources 116 is not transmitted through to the LC layer 104. The reflecting polarizer 128, however, may be used to reflect the light that would otherwise be absorbed in the lower absorbing polarizer 110, and so this light may be recycled by reflection between the reflecting polarizer 128 and the reflector 118. At least some of the light reflected by the reflecting polarizer 128 may be depolarized, and subsequently returned to the reflecting polarizer 128 in a polarization state that is transmitted through the reflecting polarizer 128 and the lower absorbing polarizer 110 to the LC layer 104. In this manner, the reflecting polarizer 128 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers, wire grid reflective polarizers or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in U.S. Pat. No. 5,882,774 (Jonza et al.), incorporated herein by reference. Commercially available examples of MOF reflective polarizers include Vikuiti™ DBEF-D200 and DBEF-D440 multilayer reflective polarizers that include diffusive surfaces, available from 3M Company, St. Paul, Minn.

Examples of suitable DRPF include continuous/disperse phase reflective polarizers as described in U.S. Pat. No. 5,825,543 (Ouderkirk et al.), incorporated herein by reference, and diffusely reflecting multilayer polarizers as described in e.g. U.S. Pat. No. 5,867,316 (Carlson et al.), also incorporated herein by reference. Other suitable types of DRPF are described in U.S. Pat. No. 5,751,388 (Larson).

Some examples of wire grid polarizers useful in connection with the present invention include those described in U.S. Pat. No. 6,122,103 (Perkins et al.). Wire grid polarizers are commercially available from, inter alia, Moxtek Inc., Orem, Utah.

Some examples of suitable cholesteric polarizer include those described in, for example, U.S. Pat. No. 5,793,456 (Broer et al), and U.S. Pat. No. 6,917,399 (Pekorny et al.). Cholesteric polarizers are often provided along with a quarter wave retarding layer on the output side, so that the light transmitted through the cholesteric polarizer is converted to linear polarization.

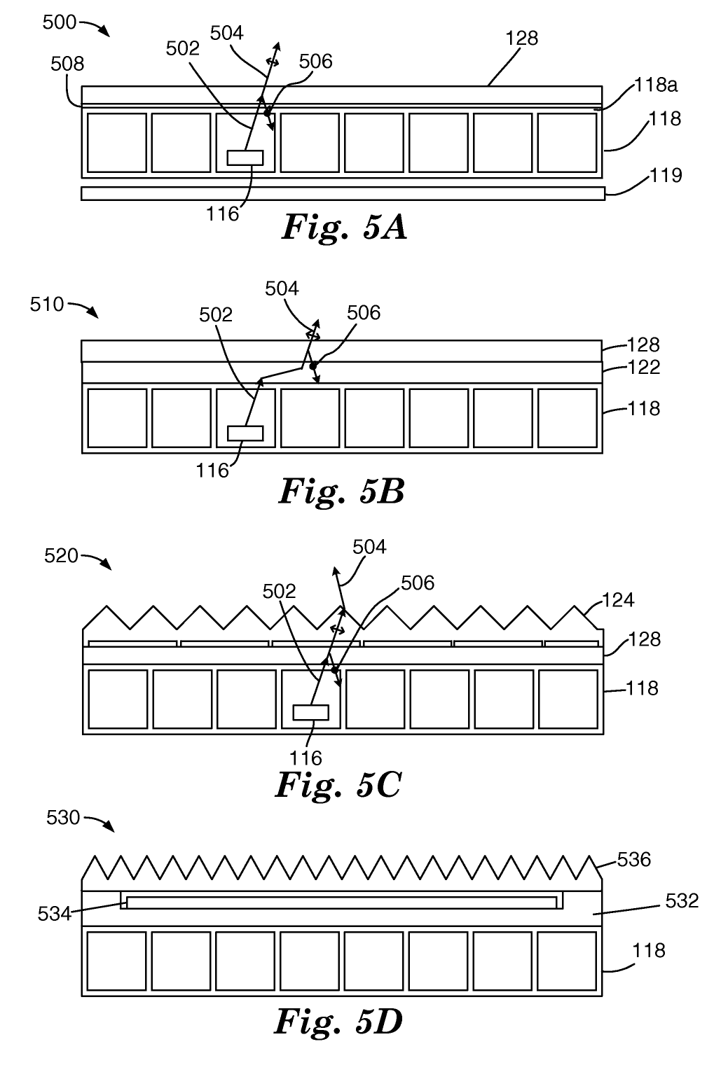

Light panel 500 having a fluted plate with an attached reflecting polarizer is schematically presented in FIG. 5A. The reflecting polarizer layer 128 is attached to the front layer 118a of the fluted plate 118. Unpolarized light 502 generated by the light sources 116 is separated into light 504 that is polarized in the state that is transmitted by the polarizer layer 128 and light 506 that is in the polarization state reflected by the polarizer layer 128. Optionally, there may be a polarization control layer 508, for example a quarter-wave retarder layer or a polarization rotation layer, disposed between the reflective polarizer layer 128 and the reflector layer 119. Passage of the reflected light through the polarization control layer 508, and subsequent reflection by the reflector 119, results in the light arriving back at the reflective polarizer layer 128 in a different polarization state from the reflected state. Therefore, at least a portion of the reflected light 506 is transmitted through the reflective polarizer layer 128. This “recycling” of light increases the brightness of the image seen by the viewer.

A diffuser layer may be positioned between the light sources 116 and the reflective polarizer layer 128. In light panel 510 schematically illustrated in FIG. 5B, a diffuser layer 122 is positioned between the reflective polarizer layer 128 and the fluted plate 118. Front layer 118a of the fluted plate 118 may itself be diffusive.

In light panel 520, schematically illustrated in FIG. 5C, a reflective polarizer layer 128 is positioned between a brightness enhancing layer 124 and the plate 118.

The fluted plate 118 is self-supporting and may, in some exemplary embodiments, be used to provide support to some or all of the light management layers. The plate 118 may be made of any suitable material, for example organic materials such as polymers. For example, the fluted plate 118 may be formed using any suitable method, for example extrusion, molding and the like.

Another exemplary embodiment 530 of fluted plate 118 attached to an arrangement of light management films is schematically illustrated in FIG. 5D. In this embodiment, a diffuser layer 532 is attached to the fluted plate 118. An intermediate layer 534 is disposed on the diffuser layer 532 and a prismatic brightness enhancing layer 536 is disposed over the intermediate layer 534. The diffuser layer 532 may be, for example, an acrylic foam tape: the foam tape deforms when the intermediate layer 534 is pushed into the foam tape, creating a recessed region that the intermediate layer 534 sits in. The intermediate layer 534 may have an optical function. For example, the intermediate layer 534 may be a reflective polarizer film, as illustrated. Examples of other suitable arrangements of light management films that may be used with a fluted plate are described in further detail in commonly owned U.S. application Ser. No. 11/244,666 (Gehlsen et al.), filed Oct. 6, 2005 and incorporated herein by reference.

Suitable polymer materials for the fluted plate may be amorphous or semi-crystalline, and may include homopolymer, copolymer or blends thereof. Polymer foams may also be used. Example polymer materials include, but are not limited to, amorphous polymers such as poly(carbonate) (PC); poly(styrene) (PS); acrylates, for example acrylic sheets as supplied under the ACRYLITE® brand by Cyro Industries, Rockaway, N.J.; acrylic copolymers such as isooctyl acrylate/acrylic acid; poly(methylmethacrylate) (PMMA); PMMA copolymers; cycloolefins; cylcoolefin copolymers; acrylonitrile butadiene styrene (ABS); styrene acrylonitrile copolymers (SAN); epoxies; poly(vinylcyclohexane); PMMA/poly(vinylfluoride) blends; atactic poly(propylene); poly(phenylene oxide) alloys; styrenic block copolymers; polyimide; polysulfone; poly(vinyl chloride); poly(dimethyl siloxane) (PDMS); polyurethanes; poly(carbonate)/aliphatic PET blends; and semicrystalline polymers such as poly(ethylene) (PE); poly(propylene) (PP); olefin copolymers, such as PP/PE copolymers; poly(ethylene terephthalate) (PET); poly(ethylene naphthalate) (PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers; and various blends that include one or more of the polymers listed.

Some exemplary embodiments of the fluted plate 118 include polymer materials that are substantially transparent to light. Some other exemplary embodiments may include diffusive material in the fluted plate 118 using, for example, a polymer matrix containing diffusing particles. The polymer matrix may be any suitable type of polymer that is substantially transparent to visible light, for example any of the polymer materials listed above. The diffusing particles may be any type of particle useful for diffusing light, for example transparent particles whose refractive index is different from the surrounding polymer matrix, diffusely reflective particles, or voids or bubbles in the matrix. Examples of suitable transparent particles include solid or hollow inorganic particles, for example glass beads or glass shells, solid or hollow polymeric particles, for example solid polymeric spheres or polymeric hollow shells. Examples of suitable diffusely reflecting particles include particles or beads of PS, PMMA, polysiloxane, titanium dioxide (TiO₂), calcium carbonate (CaCO₃), barium sulphate (BaSO₄), magnesium sulphate (MgSO₄) and the like. In addition, voids in the polymer matrix may be used for diffusing the light. Such voids may be filled with a gas, for example air or carbon dioxide.

The entire fluted plate 118 may be formed from diffusing material or selected portions of the fluted plate 118 may be made of diffusing material. For example, either the front layer 118a or the back layer 118b may be formed of diffusing material while the remainder of the fluted plate 118 is formed of some other material. In other embodiments, both the first and second layers 118a, 118b may be formed of diffusing material. When a fluted plate 118 formed of a diffusive material is used in a display system, such as is exemplified in FIG. 1, the fluted plate 118 provides mechanical support as well as providing a diffusing function, and so a separate diffuser layer may be omitted.

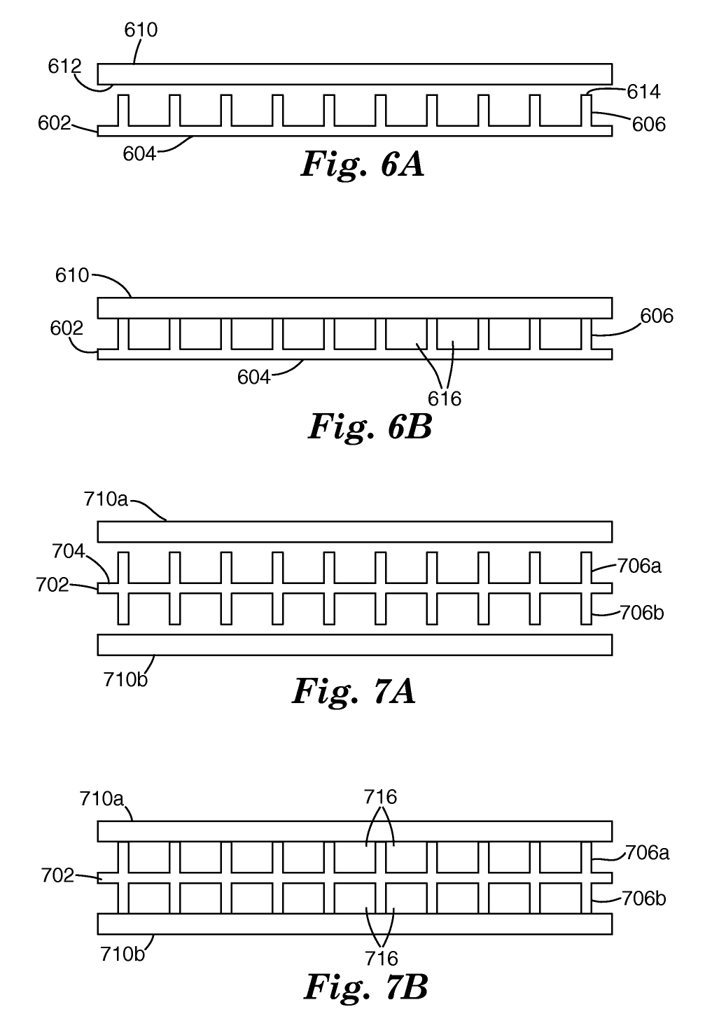

In addition to molding and extrusion, there exist other methods of manufacturing a fluted plate. One method is to attach a spine, that has connecting members already applied, to another optical film. This approach is schematically illustrated in FIGS. 6A and 6B. The spine 602 has a cross member 604 and an array of connecting members 606. The connecting members 606 may be integrated with the cross member 604. For example, the spine 602 may be formed by molding or extrusion. The spine 602 may be formed from the same types of materials as discussed earlier for a fluted plate. Thus, the spine 602 may be formed of optically transparent or optically scattering material.

An optical layer 610 is attached to the connecting members 606. The optical layer may be any suitable type of layer. For example, the layer 610 may be a prismatic brightness enhancing layer, a diffuser layer, a reflective polarizer layer, a gain diffuser layer, a lens layer, an absorbing polarizer layer, a matte layer, a transparent layer or the like. Furthermore, optical layers may also be attached to the spine 602 below the cross member 604.

FIG. 6B shows the optical layer 610 attached to the connecting members 606. The film 610 may be attached to the connecting members using any suitable method. For example, the lower surface 612 of the layer 610 and/or the tips 614 of the connecting members 606 may be applied with an adhesive which is cured after the lower surface 612 and the connecting member tips 614 are placed in contact. In another approach, in which the layer 610 and connecting members 606 are both formed of polymeric materials, the layer 610 and connecting members 606 may be placed in contact before the respective polymeric materials have been fully cross-linked, and the layer 610 and connecting members 606 are subsequently cross-linked together. Some other approaches may be used, for example contacting the optical film to the molten polymer immediately following extrusion to create a bond between the optical film and the flutes. In another approach, the flutes may be heated, (post extrusion) and laminated at a later time. Also, a coextruded flute may be employed whereby the flute is formed of one material as the matrix (non adhesive, structural member) with another material coextruded on the tip. After the film 610 has been attached, the layer 610 and spine 602 together form a plate having flutes 616.

In another embodiment, schematically illustrated in FIGS. 7A (elements separated) and 7B (elements attached together), a spine 702 has sets of connecting members 706a, 706b on respective sides of a cross member 704. Two optical layers 710a, 710b may be attached to the respective sets of the connecting members 706a, 706b. The optical layers 710a, 710b may be any desired type of optical film, such as a transparent film, a diffuser film, a prismatic brightness enhancing film, a reflective polarizing film or the like.

After at least one of the layers 710a, 710b has been attached to the spine 702, the layers 710a and 710b and spine 702 together form a plate having flutes 716.

These, and additional, methods for manufacturing a fluted plate are discussed in greater detail in U.S. patent application Ser. No. 11/276,442, referenced above.

The fluted plate may be provided with protection from ultraviolet (UV) light, for example by including UV absorbing material or material that is resistant to the effects of UV light. Suitable UV absorbing compounds are available commercially, including, e.g., Cyasorb™ UV-1164, available from Cytec Technology Corporation of Wilmington, Del., and Tinuvin™ 1577, available from Ciba Specialty Chemicals of Tarrytown, N.Y. The fluted plate may also include brightness enhancing phosphors that convert UV light into visible light.

Other materials may be included into the layers of the fluted plate to reduce the adverse effects of UV light. One example of such a material is a hindered amine light stabilizing composition (HALS). Generally, the most useful HALS are those derived from a tetramethyl piperidine, and those that can be considered polymeric tertiary amines. Suitable HALS compositions are available commercially, for example, under the “Tinuvin” tradename from Ciba Specialty Chemicals Corporation of Tarrytown, N.Y. One such useful HALS composition is Tinuvin 622.

The flutes in the plate need not be quadrilateral in shape, and may take on other shapes. It will be appreciated that many different cross-sections may be used for the connecting members and the flutes, in addition to those illustrated herein.

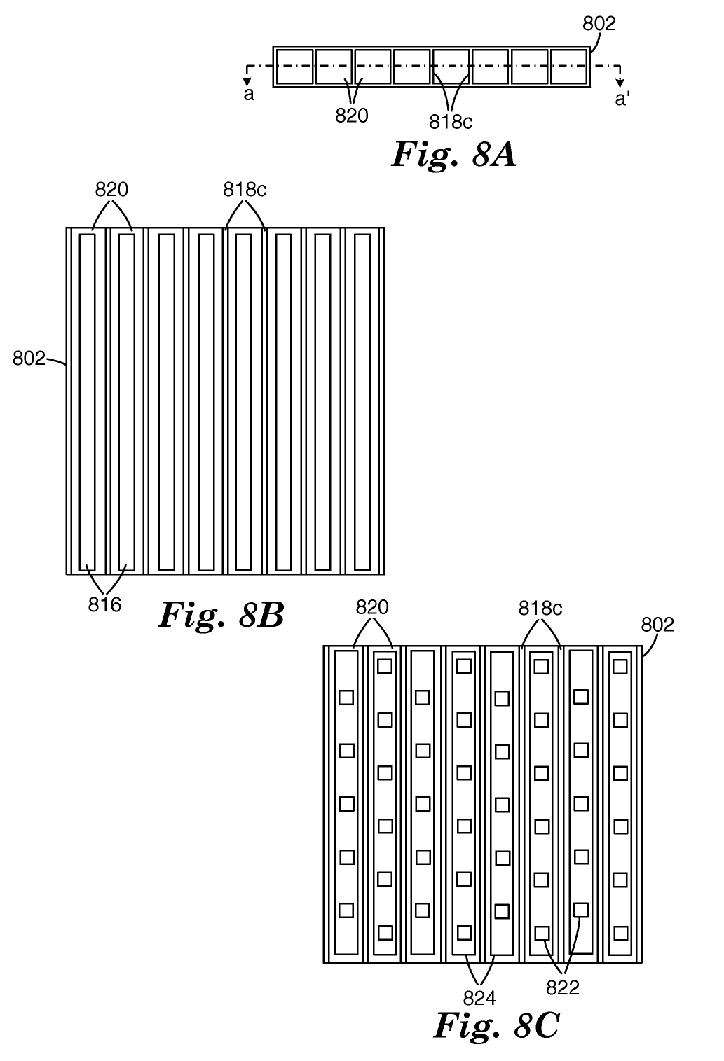

Different types of light sources may be used with the fluted plate. In particular, common examples of light sources include fluorescent lamps and light emitting diodes (LEDs), although other types of light sources may also be used. Fluorescent lamps are elongated in shape and topologically fit well into an elongated flute in the fluted plate. FIG. 8A shows a side-view of a fluted plate 802 without light sources, with a cross-section line aa′ describing the cross-sectional view through the fluted plate 802 shown in the following figures, FIGS. 8B and 8C. In the exemplary embodiment shown in cross-section in FIG. 8B, the fluorescent lamps 816 fit in at least some of the flutes 820, or spaces, between the connecting members 818c. In other exemplary embodiments, light sources may be positioned in all of the flutes 820. The light sources may extend outside the fluted plate 802. Light sources may be parallel or perpendicular to the flutes 820.

In other exemplary embodiments, LEDs are used as the light sources to illuminate the display. In some configurations, the LEDs may be placed individually within the flutes 820. In other configurations, a number of LEDs may be mounted on a strip that is located within a flute. For example, as is schematically illustrated in FIG. 8C, LEDs 822 are positioned on strips 824 that are positioned within respective flutes 820. The LEDs 822 may be provided as encapsulated LEDs, as naked LED dies mounted on a substrate, or in any other suitable configuration. The strips 824 may be formed of any suitable material that the LEDs 822 can be mounted to, for example a circuit board or a sheet of flex-strip. The strips 824 may be attached to the back layer or to the front layer of the fluted plate 802. Each strip 824 may contain LEDs 822 that produce light of different colors, for example red, green and/or blue, or may contain LEDs 822 that produce light of only a single color.

Both the fluorescent lamps 816 and the strips 824 with mounted LEDs 824 may be referred to as elongated light sources, since they each have an elongated shape.

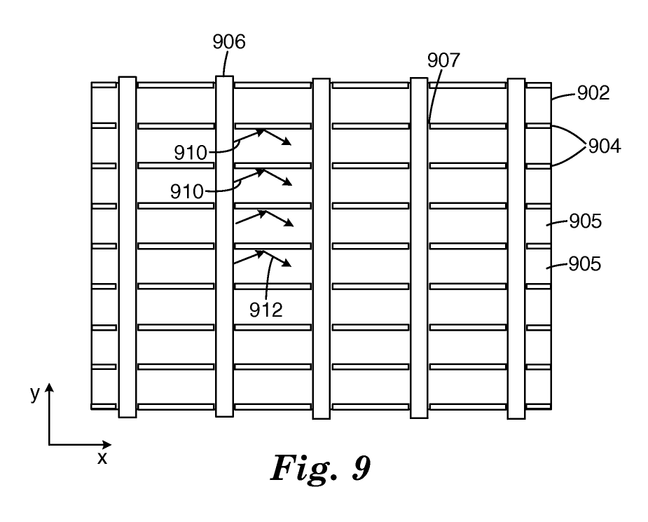

The elongated light sources need not lie along and within a respective flute, however, and may lie across one or more flutes. For example, if one or more of the connecting members are discontinuous across the fluted plate, an elongated light source may be positioned within the discontinuities of the connecting members. One such arrangement is schematically illustrated in FIG. 9, which shows a cross-section of a fluted plate 902 having a number of connecting members 904. The elongated light sources 906 lie across the connecting members, so that light 910 from a single light source 906 illuminates more than one flute. In the illustrated embodiment, the connecting members 904 lie parallel to the x-direction, and so the flutes 905 are parallel to the x-direction. The elongated light sources 906 lie parallel to the y-direction and pass from one flute 905 to the other at positions 907 where the connecting members are discontinuous. Consequently, the connecting members 904 may be used to guide light 912 within a flute 905, thus helping the light to spread out from the light source 906 so that the light panel emits light that is more uniform.

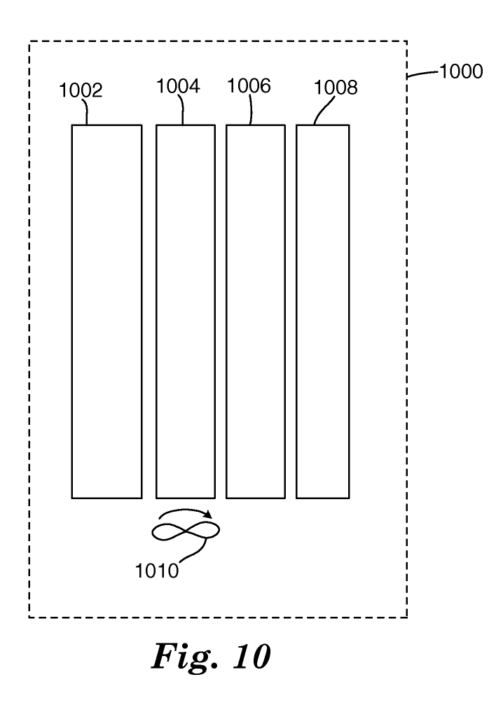

A fluted plate may be used to improve thermal management in a display system, such as a television display or monitor. An exemplary embodiment of display system 1000, schematically illustrated in FIG. 10, includes one or more light sources 1002, a fluted plate 1004, an arrangement of light management layers 1006, and a display panel 1008. A coolant may flow through the flutes of the fluted plate 1004, which results in a lower operating temperature of the display system. The coolant may be air and, in some embodiments, the air may flow through vertically oriented flutes due simply to natural convection. In other embodiments, the coolant may be forced through the flutes by a coolant circulator. For example, a fan 1010 may be used to force air through the flutes of the fluted plate 1004. In other embodiments, a transparent fluid, such as water, may be forced through the flutes by a pump. The coolant may be placed in all the flutes or in selected flutes depending on the heat removal requirements and design.

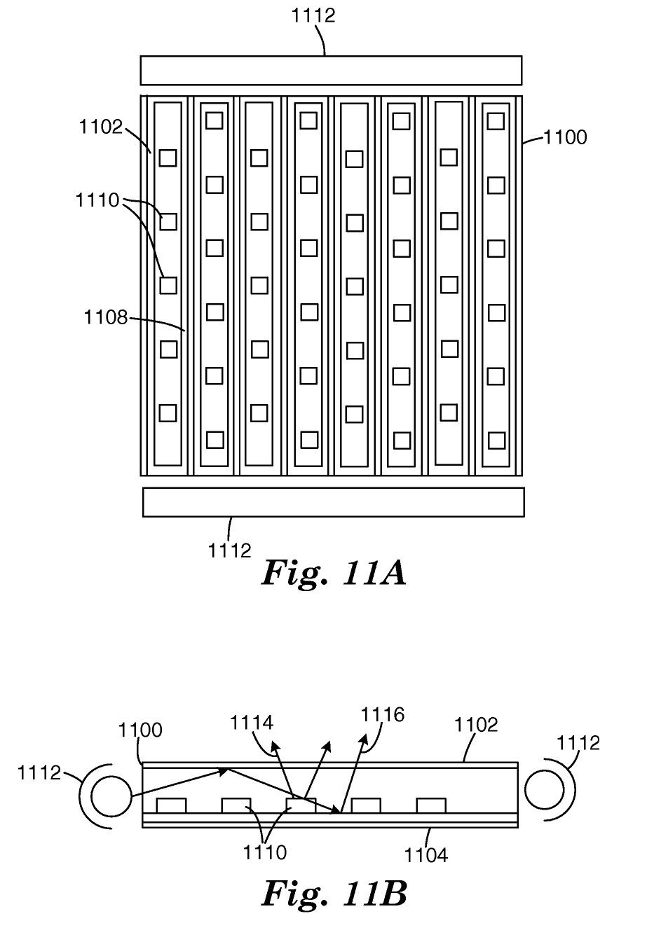

In some embodiments, the fluted plate contains light sources within the flutes and also guides light from other light sources positioned at the edge of the plate. One exemplary embodiment of such a fluted plate is schematically illustrated in FIGS. 11A and 11B. FIG. 11A presents a plan view while FIG. 11B presents a side view. The fluted plate 1100 includes an upper layer 1102, a lower layer 1004, and connecting members 1106 to form flutes 1108. A number of light sources 1110 are positioned within the flutes 1108. One or more light sources 1112 are positioned at the edge of the plate 1100. The edge-positioned light sources may be any suitable type of light source, including CCFLs and LEDs, or a combination thereof. In the illustrated embodiment, the light sources 1110 within the flutes 1108 are LEDs, while the light sources 1112 are CCFLs. Other combinations of light sources may be used.

Light 1114 from the light sources 1110 positioned within the flutes 1108 passes through the upper layer 1102 to the object being illuminated. Light 1116 from the edge-positioned light sources 1112 is reflected along the flutes 1108, within the plate 1100. Thus, the plate 1100 acts as a light guide for the light 1116. Extraction elements positioned within the plate 1100 may be used to divert the light 1116 so that it passes out of the upper layer 1102 towards the object being illuminated. The use of light sources positioned at the edge of a fluted plate that acts as a light guide is discussed in greater detail in commonly owned U.S. Application titled “EDGE-LIT OPTICAL DISPLAY WITH FLUTED OPTICAL PLATE”, having attorney docket no. 61228US002, filed on even date herewith, and incorporated by reference.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. For example, free standing optical films may also be used within a display device alongside a fluted plate that is attached with other optical layers. The claims are intended to cover such modifications and devices.

We claim:

1. A display system, comprising:
a programmable display panel having a viewing side and a back side;
a backlight unit disposed on the back side of the display panel, the backlight unit comprising a fluted plate having a front layer facing the display panel, a back layer and connecting members connecting the front and back layers, flutes being formed between the front and back layers and the connecting members, and one or more light sources disposed within at least one of the flutes of the fluted plate.

2. A system as recited in claim 1, wherein the front layer of the plate comprises one of a diffuser layer, a prismatic brightness enhancing layer and a reflective polarizer layer.

3. A system as recited in claim 1, further comprising at least one light management layer disposed between the fluted plate and the display panel.

4. A system as recited in claim 3, wherein the at least one light management layer comprises at least one of a diffuser layer, a reflecting polarizer layer and a prismatic brightness enhancing layer.

5. A system as recited in claim 1, further comprising a reflecting layer, the one or more light sources being disposed between the reflecting layer and the display panel.

6. A system as recited in claim 5, wherein the back layer of the fluted plate comprises the reflecting layer.

7. A system as recited in claim 5, wherein the reflecting layer is disposed on a back side of the fluted plate.

8. A system as recited in claim 5, the backlight unit further comprising at least one light management layer on the side of the fluted plate facing the display panel.

9. A system as recited in claim 1, wherein the one or more light sources comprises one or more fluorescent lamps disposed in respective flutes of the fluted plate.

10. A system as recited in claim 1, wherein the one or more light sources comprises one or more light emitting diodes (LEDs) disposed in respective flutes of the fluted plate.

11. A system as recited in claim 10, wherein the one or more light sources are arranged in sets, each set associated with a respective flute of the fluted plate, each set comprising at least a first LED that emits light of a first color and a second LED that emits light of a second color different from the first color.

12. A system as recited in claim 1, wherein at least some of the flutes of the fluted plate are arranged longitudinally parallel to a first direction and the one or more light sources are arranged within the flutes parallel to the first direction.

13. A system as recited in claim 1, wherein at least some of the flutes of the fluted plate are arranged longitudinally parallel to a first direction, at least some of the connecting members having breaks in a direction parallel to the first direction and at least some of the one or more light sources are arranged so as to lie within at least one of the breaks in the connecting members.

14. A system as recited in claim 13, wherein the one or more light sources comprise elongated light sources lying across more than one of the flutes of the fluted plate.

15. A system as recited in claim 1, further comprising a controller coupled to control an image displayed by the display panel.

16. A system as recited in claim 15, wherein the controller comprises a computer.

17. A system as recited in claim 15, wherein the controller comprises a television controller.

18. A system as recited in claim 1, wherein the display panel comprises a liquid crystal display panel.

19. A system as recited in claim 1, further comprising at least one lit source positioned at an edge of the fluted plate, capable of directing light into one or more of the flutes of the fluted plate.
